(19) United States
(12) Patent Application Publication
(10) Pub. No.: US 2017/0029280 A1
(43) Pub. Date: Feb. 2, 2017

(54) Graphite Exfoliation Method

(71) Applicant: 3M INNOVATIVE PROPERTIES COMPANY, St. Paul, MN (US)

(72) Inventors: David Julius, Singapore (SG); Melvin Zin, Singapore (SG); Ranjith Divigalpitiya, Ontario (CA); Gary A. Korba, Woodbury, MN (US)

(21) Appl. No.: 15/106,793

(22) PCT Filed: Dec. 11, 2014
(86) PCT No.: PCT/US2014/069803

§ 371 Date: Jun. 20, 2016

Related U.S. Application Data
(60) Provisional application No. 61/918,345, filed on Dec. 19, 2013.

(51) Int. Cl. C01B 31/04; C09D 127/12; C08K 3/04; C09D 5/24; C08K 7/00

(52) U.S. Cl. CPC C01B 31/0469; C09D 5/24; C08K 7/00; C08K 3/04; C09D 127/12; C08K 2201/001; C08K 2201/011

(57) ABSTRACT

A method of producing an aqueous dispersion of few-layer graphene nanosheets is disclosed, the method including: (a) mixing graphite particles with a perfluorosulfonate ionomer in an aqueous liquid, to form an aqueous dispersion of graphite particles; and (b) sonicating the aqueous dispersion of graphite particles to form an aqueous dispersion of few-layer graphene nanosheets, wherein the perfluorosulfonate ionomer is disposed as a thin and continuous layer on the few-layer graphene nanosheets. A composition is also disclosed, comprising an aqueous dispersion of a mixture of: (a) a perfluorosulfonate ionomer; and (b) a plurality of few-layer graphene nanosheets; wherein the perfluorosulfonate ionomer is disposed as a thin and continuous layer on the few-layer graphene nanosheets.

### TECHNICAL FIELD

The present disclosure relates generally to methods for exfoliating graphite to produce aqueous dispersions of few-layer graphene. In particular, the disclosure relates to methods for exfoliating graphite to produce an aqueous dispersion of few-layer graphene nanosheets in the presence of a fluorinated sulfonate ionomer.

### BACKGROUND

The term “graphene” is often used in the art in reference to a single atom thick planar sheet of sp²-bonded carbon atoms which are positioned in a honeycomb crystal lattice. The term “graphene” is also sometimes used in the art in reference to structures having a small number of graphene layers and similar properties. The distinctive structure of graphene confers many unique mechanical, electronic, thermal, optical and magnetic properties upon it.

Graphene reportedly has high electron mobility, up to 2×10⁵ cm²V⁻¹s⁻¹ at room temperature. In theory, this is due to the ease with which electrons can move through the lattice, the lattice being free of imperfections and heteroatoms. The thermal conductivity of graphene is reported to be remarkably elevated, even larger than thermal conductivities measured for carbon nanotubes and diamond. This combination of properties makes graphene a promising candidate to take the place of silicon as a new generation of materials in the semiconductor industry. Graphene may also have widespread potential applications in electronics and optoelectronics such as field-effect transistors, light-emitting diodes, solar cells, sensors and panel displays. It has been both theoretically predicted and experimentally demonstrated, that size, composition and edge geometry of graphene are important factors, which determine its overall electronic, magnetic, and optical and catalytic properties due to strong quantum confinement and edge effects. For example, by cutting graphene sheets to long and narrow ribbons (GNR) (width less than 10 nm) it is reportedly possible to induce a direct band gap in graphene, that renders GNRs semiconducting (M. Y. Han, et al. Phys. Rev. Lett., 2007, 98, 206805-206808). Further confinement in the basal plane (overall dimensions smaller than 100 nm) can reportedly lead to graphene quantum dots (“GQDs”) with zero dimensions. The suppressed hyperfine interaction and weak spin-orbit coupling make GQDs interesting candidates for spin “qubits” with long coherence times for future quantum information technology (A. Donarini, et al. Nano Lett., 2009, 9, 2897-2902.). It has been noted that graphene sheets with reduced lateral dimensions in the form of nano-ribbons or quantum dots can effectively tune the bandgap of graphene and facilitate the lateral scaling of graphene in nanoelectronic devices. In this context it has become urgent to develop effective routes for tailoring the graphene structures (J. Lu, et al. Nat. Nanotechnol. 2011, 6, 247-252; and L. A Ponomarenko, etal., Science, 2008, 320, 356-358).

Currently, there are a number of possible methods by which graphene sheets may be fabricated, which include chemical vapor deposition, micromechanical cleavage, epitaxial growth and chemical exfoliation. Compared with other techniques, chemical exfoliation, which involves the direct exfoliation of various solid starting materials, such as graphite oxide, expanded graphite and natural graphite, is advantageous in terms of simplicity, cost and high volume production. However, currently explored chemical solution exfoliation methods have a number of drawbacks that need to be addressed.

The most commonly used chemical exfoliation method employs the chemical oxidation of graphite to negatively charged graphite oxide sheets, which can be readily exfoliated as individual graphene oxide sheets by ultrasonication in water. To restore graphene's unique properties the oxygen containing groups are removed by chemical reduction; however without the charges, the strong Van der Waals interactions among the reduced graphene sheets result in their immediate coalescence and restacking. Very recently it was found that the addition of ammonia in the aqueous solution can lead to stable aqueous dispersions of graphene because of the electrostatic repulsion from the negatively charged carboxylic acid groups that remain on the surface of the sheets. Other attempts to prevent graphene aggregation have mainly focused on coating the graphene oxide surface with a dispersant phase, usually a surfactant, resulting in weak internanosheet repulsions.

Another disadvantage of the known chemical exfoliation methods is that many of the chemicals used are either expensive or toxic and need careful handling, leading to environmentally unfriendly and unsustainable approaches. Furthermore, the majority of chemical solution exfoliation methods involve extremely time-consuming multiple steps that sometimes last for several days. For example, the oxide defects present in graphene oxide can be removed by thermal, or a combination of chemical and thermal, reduction which adds another step in the processing procedure. In addition, thermal reduction is most successfully carried out at about 1000° C., a temperature which is unsuitable for many applications.

Alternative processes, which overcome the above mentioned obstacles, and allow for the formation of high-quality graphene, have therefore been investigated. To date, some progress has been achieved.

Coleman et al. have purportedly demonstrated (Nature Nanotechnology, 2008, 3, 563-568) that it is possible to exfoliate graphite to produce single- and few-layer graphene by judiciously choosing a solvent which ensures a strong interaction between solvent and graphene surface. However, the yield of this process is small and not appropriate for mass scale production. Direct exfoliation of graphene in organic solutions reportedly improves the yield, but this is achieved only following prolonged sonication times approaching 3 weeks in duration or extended ultracentrifugation.

Liu et al. reported (Chem. Commun., 2010, 46, 2844-2846) that single layered and bilayered graphene sheets can be produced by a direct exfoliation from graphite flakes in the presence of single stranded DNA using sonication. Production of graphene sheets from graphite by sonication in ionic liquids has also been reported by Wang et al. (Chem Commun., 2010, 46, 2844-2846), and Frazier et al. (WO 2010/065346). However, the graphene sheets produced by these techniques still contained a large fraction of oxygen (e.g., more than 10 atom percent), similar to that found in graphene reduced from graphene oxide. A low fraction of oxygen in graphene is difficult to achieve and may significantly influence the property and application of graphene. Thus, an alternative process capable of making graphene sheets of high quality is desirable.

A practical, high-yield exfoliation of graphite to produce graphene dispersions suitable, for example, for the manufacture of production of transparent conductive films for electronic devices, remains a challenge.

### SUMMARY

The present disclosure provides a simple and scalable method for exfoliating graphite directly into remarkably stable aqueous dispersions of few-layer graphene sheets, where the dispersions include a perfluorosulfonate ionomer.

In a first aspect, the present disclosure provides a method of producing an aqueous dispersion of few-layer graphene nanosheets, the method including: (a) mixing graphite particles with a perfluorosulfonate ionomer in an aqueous liquid, to form an aqueous dispersion of graphite particles; and (b) sonicating the aqueous dispersion of graphite particles to form an aqueous dispersion of few-layer graphene nanosheets, wherein the perfluorosulfonate ionomer is disposed as a thin and continuous layer on the few-layer graphene nanosheets.

In a second aspect, the present disclosure provides an aqueous dispersion of a mixture of: (a) a plurality of few-layer graphene nanosheets; and (b) a perfluorosulfonate ionomer; wherein the perfluorosulfonate ionomer is disposed as a continuous and thin layer on few-layer graphene nanosheets in the plurality of few-layer graphene nanosheets.

In a third aspect, the present disclosure provides a method of providing a coated article, the method including providing a substrate, and applying the aqueous dispersion of the second aspect to the substrate.

The above summary of the present disclosure is not intended to describe each embodiment of the present invention. The details of one or more embodiments of the invention are also set forth in the description below. Other features, objects, and advantages of the invention will be apparent from the description and from the claims.

### DETAILED DESCRIPTION

In the following detailed description, various sets of numerical ranges (for example, of the number of carbon atoms in a particular moiety, of the amount of a particular component, or the like) are described, and, within each set, any lower limit of a range can be paired with any upper limit of a range. Such numerical ranges also are meant to include all numbers subsumed within the range (for example, 1 to 5 includes 1, 1.5, 2, 2.75, 3, 3.80, 4, 5, and so forth).

As used herein, the term “and/or” means one or all of the listed elements or a combination of any two or more of the listed elements.

The words “preferred” and “preferably” refer to embodiments of the present disclosure that may afford certain benefits under certain circumstances. Other embodiments may also be preferred, however, under the same or other circumstances. Furthermore, the recitation of one or more preferred embodiments does not imply that other embodiments are not useful, and is not intended to exclude other embodiments from the scope of the invention.

The term “comprises” and variations thereof do not have a limiting meaning where these terms appear in the description and claims.

As used herein, “a,” “an,” “the,” “at least one,” and “one or more” are used interchangeably.

The present disclosure relates to methods for the preparation of dispersions of few-layer graphene, and the few-layer graphene dispersions produced by the method. The term “graphene” is used herein to refer to a single atom thick planar sheet of sp²-bonded carbon atoms which are positioned in a honeycomb crystal lattice. In the context of the present disclosure, the term “few-layer graphene” is intended to refer to more than one, but not more than 10, of these single sheets of graphene arranged in a layered structure. Preferred numbers of layers will thus be 2 to 10, preferably 2 to 8, more preferably 2 to 5, or any number of layers within those ranges. Where the few-layer graphene, whether it be two sheets or even up to 10 sheets arranged in a layered structure, has a surface area of more than 0.005 micrometer² (e.g. more than 0.08 micrometer²), preferably 0.006 to 0.038 micrometer² (and which may be 0.5 micrometer² (e.g. 0.45 micrometer²) or even greater), the few-layer graphene may be referred to as being in the form of “nanosheets” in the context of the disclosure. if, however, the surface area of the few-layer graphene is lower, it may be referred to as being in the form of “nanodots” (e.g. having a surface area of less than 0.5 micrometer² such as less than 0.08 micrometer²). In the context of the present disclosure, the term nariodot is used to refer to a few-layer graphene sheets having a diameter of less than 20 nm, for example 10 nm or less.

The term “graphite” is well known to those skilled in the art and is used herein to convey its traditional meaning of a layered planar structure, each layer comprising a sheet of sp²-bonded carbon atoms. Graphite as referred to herein has at least 11 layers of this hexagonal carbon, which are held together by weak Van der Waals forces. In all embodiments of the present disclosure, the graphite may be of any type from any source but it is preferable that the graphite is natural graphite, i.e., the unprocessed material.

The term “aqueous” refers to media that includes 5 weight percent (“wt. %”) water, and an aqueous dispersion can optionally include water miscible solvents, for example, C1 to C4 alcohols (e.g., methanol, ethanol, n-propanol, isopropyl alcohol), including linear forms of the alcohols and their various isomers. A preferred water miscible solvent is ethanol. Suitable volume ratios of the optional water-miscible solvent to water in the aqueous dispersion can be 0:1, or can be in a range from 0.1:1 to 10:1, or preferably from 0.5:1 to 1.5:1, including any ratio between those endpoints.

The method of the present disclosure comprises the steps of mixing graphite particles with a perfluorosulfonate ionomer in an aqueous liquid, to form an aqueous dispersion, and sonicating the aqueous dispersion for a limited time to form an aqueous dispersion of few-layer graphene nanosheets. The graphite can take any form but is preferably natural graphite. The use of natural graphite as a starting material not only helps to decrease the cost of the processes of the invention compared to others known in the art, which use expanded graphite or graphene oxide, but also helps to minimize the presence of oxygen-containing groups in the final product.

For aqueous dispersions of the present disclosure, the few-layer graphene nanosheets are coated with a thin and continuous layer of ionomeric material. In some embodiments, the thickness of the thin and continuous layer of ionomeric material is at least 1 nm, at least 2 nm, or even at least 5 nm. In some embodiments, the thickness of the thin and continuous layer of ionomeric material is up to 100 nm, up to 90 nm, up to 80 nm, up to 70 nm, 1 up to 60 nm, up to 50 nm, up to 40 nm, up to 30 nm, up to 20 nm, or even up to 10 nm. In some embodiments, the thickness of the thin and continuous layer of ionomeric material is in a range from 1 to 100 nm, from 2 to 100 nm, from 2 to 50 nm, from 2 to 40 nm, from 2 to 30 nm, from 2 to 20 nm, or even from 2 to 10 nm. By “continuous” is meant that at least 80%, at least 90%, at least 95%, or even at least 98% of the surface of the few-layer graphene nanosheets is coated with the a thin layer of ionomeric material. Thickness and continuity of the thin and continuous layer of ionomeric material can be assessed by suitable analytical techniques, including, for example, time-of-flight mass spectrometry (TOF-MS).

In some instances, individual few-layer graphene nanosheets may be coated on all surfaces with the thin and continuous layer of ionomer. In some other instances, more than one few-layer graphene nanosheet may share a thin and continuous layer of ionomer (i.e., the thin and continuous layer of ionomer may bridge across two or more few-layer graphene nanosheets). However, the aqueous dispersion remains as a liquid, preferably suitable for solution processing (e.g., spraying) for application to a substrate.

In some embodiments, the ionomeric material is a perfluorosulfonate ionomer. In some other embodiments, the ionomeric material can include other ionomers, for example, highly fluorinated sulfonate ionomers. By “highly fluorinated” is meant containing fluorine in an amount of 40 wt % or more, typically 50 wt % or more and more typically 60 wt % or more. The ionomeric material is preferably a perfluorosulfinate ionomer.

Highly-fluorinated and perfluorosulfonate ionomers are known in the art and can be used in methods of the present disclosure. For example, copolymers of tetrafluoroethylene (TFE) and a co-monomer according to the formula: FSO₂—CF₂—CF₂—O—CF(CF₃)—CF₂—O—CF═CF₂ are known and sold in sulfonic acid form, (i.e., with the S0₂F end group hydrolyzed to —SO₃H), under the trade designation “NAFIONO” by DuPont Chemical Company, Wilmington, Del. NAFIONO is commonly used, for example, in making polymer electrolyte membranes for use in fuel cells.

Copolymers of tetrafluoroethylene (TFE) and a co-monomer according to the formula: FSO₂—CF₂—CF₂—O—CF═CF₂ are also known and used in sulfonic acid form (i.e., with the —SO₂F end group hydrolyzed to —SO₃H), and are useful, for example, in making polymer electrolyte membranes for use in fuel cells, and can be useful in graphite exfoliation methods of the present disclosure. As disclosed in PCT WO 00/79629 (Hamrock et al.), other ionomeric polymers useful in the present invention may be fluorinated, including partially fluorinated and, more preferably, fully fluorinated, such as a terpolymer of tetrafluoroethylene, hexafluoropropylene and vinylidene fluoride (e.g., “THV” series terpolymers available from 3M Advanced Materials, Oakdale, MN), which terpolymers are thus composed of —CF₂—CF₂—, —CH₂—CF₂—, and —CF(CF₃)—CF₂— units.

Sonicating the aqueous dispersion of graphite particles is preferably performed for a period of no more than 24 hours. This is in contrast to previous methods which use sonication for many days. The duration of sonicating will more preferably for no more than 15 hours, or even no more than 12 hours. The sonicating can be performed using any suitable sonicating instrument, for example an ultrasonic bath or an ultrasonic probe, colloquially known as a sonicator.

The method of the present disclosure preferably produces few-layer graphene nanosheets in yields of up to 10 wt. %, up to 5 wt. %, 4 wt. %, 3 wt. %, 2 wt. %, or even up to 1 wt. %, relative to the initial amount of graphite starting material. In some embodiments, the few-layer graphene nanosheets are produced in yields of at least 0.1 wt. %, at least 0.2 wt. %, 0.3 wt. %, 0.4 wt. %, or even at least 0.5 wt. %, relative to the initial amount of graphite starting material. Any amount few-layer graphene nanosheets in a range from 0.1 wt. % to 10 wt. %, from 0.2 wt. % to 5 wt. %, or even from 0.5 wt. % to 2 wt. % can be produced, relative to the initial amount of graphite starting material.

Where the few-layer graphene is in the form of nanosheets, these may comprise multiple layers of graphene. A preferred number of layers is in the range of 2 to 10, and more preferably 2 to 5. A highly preferred number of layers is 2.

Where the few-layer graphene is in the form of nanodots, these are preferably substantially uniform. In all embodiments of the invention, the diameter of the nanodots is preferably in the range of less than 20 nm, more preferably less than 10 nm. The nanodots of the disclosure preferably have a height of between 1 and 3 nm.

The oxygen content of the few-layer graphene produced by the method of the present disclosure is preferably no greater than 5 atom percent (“at %”), more preferably no greater than 4 at %, and even more no greater than 3 at %. Without being bound by theory, it is thought that any oxygen atoms that might be present in the few-layer graphene produced by the method of the present disclosure would have been present as a result of pre-existing oxygen atoms present in the graphite starting material, and not incorporated during the mixing and grinding process. Notwithstanding the presence of a low level of oxygen atoms, it is preferable in the few-layer graphene produced by the method of the present disclosure is substantially free of other contaminants, including those which are chemically bound to the few-layer graphene. In particular, contaminants such as fluorine, nitrogen, phosphorus and sulfur are preferably substantially absent from the few-layer graphene produced. Herein by “substantially absent” is indicated a level of impurity around or below the detection limit of X-ray photoelectron spectroscopy (“XPS”). Typically, such a level will be less than 1 at %, being the practical resolution limit of XPS. The absence of such impurities means that the method of the disclosure offers an improvement in quality over other (e.g. chemical) methods known in the art for the production of few-layer graphene. The few-layer graphene resulting from the method of the present disclosure is also preferably free or substantially free from structural defects.

Raman scattering is a convenient, powerful macroscopic tool for the characterization of graphene-containing samples. The layer number and quality of few-layer graphene can be distinguished by the analysis of spectroscopic intensity, frequency and line width etc., as will be appreciated by those having skill in the art.

Stability of dispersions of the present disclosure can be measured, for example, by measuring a zeta potential of the dispersion. Without being bound by theory, it is thought that a magnitude of the zeta potential gives an indication of the potential stability of the colloidal system. The higher absolute (either negative or positive) zeta potential of samples that include ionomer can indicate that produced few-layer graphene nanosheets in medium tend to repel each other, thus limiting the opportunity for the particles to come closer, and thus ensuring the stability of colloidal system. The lower absolute values of zeta potential control samples (i.e., samples without ionomer), on the other hand, tend to show poor stability that results in precipitation.

A composition of the present disclosure includes an aqueous dispersion of a mixture of: (a) a perfluorosulfonate ionomer; and (b) a plurality of few-layer graphene nanosheets. The aqueous dispersion is useful, for example, as a coatable composition for providing a coating of few-layer graphene nanosheets dispersed in a perfluorosulfonate ionomer. Such coatable compositions can be useful, for example, for applying a conductive coating on a substrate. Suitable substrates can include any of a broad range of materials, including, for example, any of glasses, metals, plastics, ceramics, and the like.

Coating compositions of the present disclosure are useful for solution processing, for example, by any of spraying, brushing, or use of a slot die. The coating compositions can, for example, be applied to a substrate via a metered application, such as use of a slot die. Spraying may also allow metered application.

### SELECT EMBODIMENTS OF THE PRESENT DISCLOSURE Various embodiments are provided that include the following items:

1. A method of producing an aqueous dispersion of few-layer graphene nanosheets, the method comprising:

(a) mixing graphite particles with a perfluorosulfonate ionomer in an aqueous liquid, to form an aqueous dispersion of graphite particles; and

(b) sonicating the aqueous dispersion of graphite particles to form an aqueous dispersion of few-layer graphene nanosheets;

wherein the perfluorosulfonate ionomer is disposed as a thin and continuous layer on the few-layer graphene nanosheets.
2. The method of item 1, wherein, prior to the sonicating, a concentration of the graphite particles in the aqueous dispersion of graphite particles is in a range from 0.5 mg/mL to 5 mg/mL, relative to a total volume of the aqueous dispersion of graphite particles.
3. The method of item 1 or item 2, wherein prior to the sonicating, a weight ratio of the perfluorosulfonate ionomer to the graphite particles in the aqueous dispersion of graphite particles is in a range from 0.1:1 to 10:1.
4. The method of any one of items 1 to 3, wherein the aqueous dispersion of few-layer graphene nanosheets further comprises a water-miscible solvent.
5. The method of any one of items 1 to 4, wherein the water-miscible solvent is a C1 to C4 alcohol.
6. The method of item 5, wherein the water-miscible solvent is ethanol.
7. The method of any one of items 4 to 6, wherein a volume ratio of the ethanol and water in the aqueous dispersion of few-layer graphene nanosheets is in a range from 0.5:1 to 1.5:1.
8. The method of any one of items 1 to 7, wherein the sonicating is carried out for no more than 24 hours.
9. The method of any one of items 1 to 8, wherein the aqueous dispersion of few-layer graphene nanosheets remains dispersed for a period of at least one month after the sonicating.
10. The method of any one of items 1 to 9 not including the use of any reducing agent and/or oxidizing agent.
11. The method of any one of items 1 to 10, wherein the continuous and thin layer of perfluorosulfonate ionomer has a thickness in a range of 2 nm to 100 nm.
12. A composition comprising an aqueous dispersion of a mixture of:

(a) a plurality of few-layer graphene nanosheets; and

(b) a perfluorosulfonate ionomer;

wherein the perfluorosulfonate ionomer is disposed as a continuous and thin layer on few-layer graphene nanosheets in the plurality of few-layer graphene nanosheets.
13. The composition of item 12, wherein the plurality of few-layer graphene nanosheets is present in a range from 0.5 mg/mL to 5 mg/mL, relative to a total volume of the aqueous dispersion.
14. The composition of item 12 or item 13, wherein a weight ratio of the perfluorosulfonate ionomer to the few-layer graphene nanosheets is in a range from 0.1:1 to 10:1.
15. The composition of any one of items 12 to 14, wherein the aqueous dispersion further comprises a water-miscible solvent.
16. The composition of item 15, wherein the water-miscible solvent is a C1 to C4 alcohol.
17. The composition of any one of items 15 to 16, wherein a volume ratio of the water-miscible solvent and water in the aqueous dispersion is in a range from 0.5:1 to 1.5:1.
18. The composition of any one of items 12 to 17, wherein the aqueous dispersion has a lifetime as a stable dispersion of at least one month.
19. The composition of any one of items 12 to 18, wherein the continuous and thin layer of perfluorosulfonate ionomer has a thickness in a range of 2 nm to 100 nm.
20. The composition of any one of items 12 to 19, wherein oxygen content of the few-layer graphene nanosheets is no greater than 5 at %.

21. The composition of any one of items 12 to 19, wherein oxygen content of the few-layer graphene nanosheets is no greater than 3 at %.

22. A method of providing a coated article, the method comprising:

(a) providing a substrate; and

(b) applying the composition of any one of items 12 to 21 to the substrate.

23. The method of any one of items 1 to 11, wherein oxygen content of the few-layer graphene nanosheets is no greater than 5 at %.
24. The method of one of items 1 to 11, wherein oxygen content of the few-layer graphene nanosheets is no greater than 3 at %.

### EXAMPLES

### Test Methods

Zeta potentials were measured using a Malvern ZETASIZER analyzer (obtained from Malvern Instruments, Ltd., Worcestershire, UK). For preparation of sample solutions, a 5 mL aliquot of each sample was withdrawn and place into a glass cuvette for measurement of the zeta potential of the sample. For benchmark, a 5 mL aliquot of a control sample (i.e., without NAFIONO) was also tested.

Raman spectroscopy of films made from the few-layer graphene colloidal dispersions was performed using a MICRORAMAN spectrometer (obtained from CRAIC Technologies, San Dimas, Calif.), using an excitation wavelength of 633 nm. For preparation of film sample, 0.5 mL stock solution of samples were withdrawn and coated onto glass slides, allowing them to dry. For benchmark, a 0.5 mL aliquot of a control sample (i.e., without NAFIONO) was also tested.

### Materials

Deionized water was used in all studies. Ethanol (Analytical grade, 95 wt. %) was obtained from Merck, Inc., and used as received.

| Designation | Description and Source |
|---|---|
| Graphite A | Natural flake graphite, obtained from Asbury |
| | Carbons, Asbury, NJ, under the trade designation |
| | “GRAPHITE FLAKES GRADE 3610” |
| Graphite B | Natural flake graphite, obtained from Asbury |
| | Carbons, Asbury, NJ, under the trade designation |
| | “GRAPHITE FLAKES GRADE 3763” |
| PFSA solution | A perfluorosulfonate ionomer, as a 5 wt. % mixture |
| | in alcohol, obtained from Sigma Aldrich Co., St. |
| | Louis, MO, under the trade designation |
| | “NAFION ® PERFLUOROSULFONATE |
| | IONOMER” |

For each of working examples EX-1 to EX-3, a 50 mg sample of “Graphite A” was add to 20 mL of a mixture of ethanol and water (water/ethanol ratio 1:1 by volume) and this mixture was combined with an aliquot of PFSA solution to give PFSA/graphite weight ratios of 1:1, 2:1, and 3:1 (solution amounts are shown in Table 1, and the calculated amount of PFSA is shown in milligrams). A comparative example CE-1 was also provided, having no added PFSA solution (resulting in a PFSA/graphite weight ratio of 0).

TABLE 1

| | | PFSA | | Weight ratio |
|---|---|---|---|---|
| | Graphite A, | solution, | PFSA, | of PFSA to |
| EXAMPLE | mg | g | mg | graphite |
| CE-1 | 50 | 0 | 0 | 0 |
| EX-1 | 50 | 1 | 50 | 1 |
| EX-2 | 50 | 2 | 100 | 2 |
| EX-3 | 50 | 3 | 150 | 3 |

Each of the initial aqueous dispersions of graphite particles for EX-1 to EX-3 and CE-1 was contained in a capped clear vial, and was sonicated for 15 hours using an ultrasonic bath (using a “BRANSON 3510 ULTRASONIC BATH”, operated at 40 kHz, 100W). The vials of sonicated samples were then kept at room temperature (in a range of about 20° C. to 25° C.) for one month. Visual observation of the 1 month-old samples EX-1, EX-2, and EX-3 showed visual evidence that a colloidal dispersion was still present. The 1 month-old CE1 sample did not show visual evidence of a colloidal dispersion, but rather showed visual evidence of aggregation and precipitation of the graphite flakes. Zeta potentials were determined for the CE-1, EX-1 and EX-3 samples, with the results as summarized in Table 2.

TABLE 2

| | Weight ratio | Zeta potential of 1 |
|---|---|---|
| | of PFSA to | month-old sonicated |
| EXAMPLE | graphite | sample, millivolts |
| CE-1 | 0 | −9.8 |
| EX-1 | 1 | −12.7 |
| EX-3 | 3 | −15.6 |

For each of working examples EX-4 to EX-6, a 500 mg sample of “Graphite A” was add to 20 mL of a mixture of ethanol and water (water/ethanol ratio 1:1 by volume) and this mixture was combined with an aliquot of PFSA solution to give PFSA/graphite weight ratios of 1:1, 3:1, and 5:1 (solution amounts are shown in Table 3, and the calculated amount of PFSA is shown in milligrams). A comparative example CE-2 was also provided, having no added PFSA solution. The samples were sonicated for 15 hours using an ultrasonic bath (using a “BRANSON 3510 ULTRASONIC BATH”, operated at 40 kHz, 100W). The vials of sonicated samples were then kept at room temperature (in a range of about 20° C. to 25° C.) for one month. After one month the zeta potentials of the sonicated mixtures were measured, with the results as summarized in Table 3.

For each of working examples EX-7 to EX-9, a 500 mg sample of “Graphite B” was add to 20 mL of a mixture of ethanol and water (water/ethanol ratio 1:1 by volume) and this mixture was combined with an aliquot of PFSA solution to give PFSA/graphite weight ratios of 1:1, 3:1, and 5:1 (solution amounts are shown in Table 3, and the calculated amount of PFSA is shown in milligrams). A comparative example CE-3 was also provided, having no added PFSA solution. The samples were sonicated for 15 hours using an ultrasonic bath (using a “BRANSON 3510 ULTRASONIC BATH”, operated at 40 kHz, 100W). The vials of sonicated samples were then kept at room temperature (in a range of about 20° C. to 25° C.) for one month. After one month the zeta potentials of the sonicated mixtures were measured, with the results as summarized in Table 3.

TABLE 3

| | | Weight ratio | Zeta potential of 1 |
|---|---|---|---|
| | Graphite | of PFSA to | month-old sonicated |
| EXAMPLE | type | graphite | sample, millivolts |
| CE-2 | Graphite A | 0 | −7.8 |
| EX-4 | Graphite A | 1 | −18.2 |
| EX-5 | Graphite A | 3 | −18.8 |
| EX-6 | Graphite A | 5 | −17.2 |
| CE-3 | Graphite B | 0 | −7.0 |
| EX-7 | Graphite B | 1 | −18.8 |
| EX-8 | Graphite B | 3 | −19.8 |
| EX-9 | Graphite B | 5 | −18.6 |

Regarding the zeta potential measurements, and without being bound by theory, a more negative or positive zeta potential is thought to give an indication of an improved stability of the colloidal system. The higher absolute (negative/positive) zeta potential of aqueous dispersion that included ionomer showed that the few-layer graphene nanosheets produced in aqueous medium tended to repel each other, limiting the chances for the particles to come closer, thus ensuring the stability of the colloidal system. Lower values of zeta potential in control samples (i.e., samples without ionomer) showed poorer stability of dispersions, which resulted in precipitation.

Raman scattering data of samples prepared from the month-old EX-5 mixture was consistent with the presence of few-layer graphene stacked orderly (narrow peak at 2700 cm⁻¹), instead of single layer graphene.

Other modifications and variations to the present disclosure may be practiced by those of ordinary skill in the art, without departing from the spirit and scope of the present disclosure. It is understood that aspects of the various embodiments may be interchanged in whole or part or combined with other aspects of the various embodiments. The preceding description, given in order to enable one of ordinary skill in the art to practice the claimed disclosure, is not to be construed as limiting the scope of the disclosure, which is defined by the claims and all equivalents thereto.

1. A method of producing an aqueous dispersion of few-layer graphene nanosheets, the method comprising:
(a) mixing graphite particles with a perfluorosulfonate ionomer in an aqueous liquid, to form an aqueous dispersion of graphite particles; and
(b) sonicating the aqueous dispersion of graphite particles to form an aqueous dispersion of few-layer graphene nanosheets;
wherein the perfluorosulfonate ionomer is disposed as a thin and continuous layer on the few-layer graphene nanosheets.

2. The method of claim 1, wherein, prior to the sonicating, a concentration of the graphite particles in the aqueous dispersion of graphite particles is in a range from 0.5 mg/mL to 5 mg/mL, relative to a total volume of the aqueous dispersion of graphite particles.

3. The method of claim 1 or claim 2, wherein prior to the sonicating, a weight ratio of the perfluorosulfonate ionomer to the graphite particles in the aqueous dispersion of graphite particles is in a range from 0.1:1 to 10:1.

4. The method of claim 1, wherein the aqueous dispersion of few-layer graphene nanosheets further comprises a water-miscible solvent.

5. The method of claim 1, wherein the water-miscible solvent is a C1 to C4 alcohol.

6. The method of claim 5, wherein the water-miscible solvent is ethanol.

7. The method of claim 1, wherein a volume ratio of the ethanol and water in the aqueous dispersion of few-layer graphene nanosheets is in a range from 0.5:1 to 1.5:1.

8. The method of claim 1, wherein the sonicating is carried out for no more than 24 hours.

9. The method of claim 1, wherein the aqueous dispersion of few-layer graphene nanosheets remains dispersed for a period of at least one month after the sonicating.

10. The method of claim 1 not including the use of any reducing agent and/or oxidizing agent.

11. The method of claim 1, wherein the continuous and thin layer of perfluorosulfonate ionomer has a thickness in a range of 2 nm to 100 nm.

12. A composition comprising an aqueous dispersion of a mixture of:
(a) a plurality of few-layer graphene nanosheets; and
(b) a perfluorosulfonate ionomer;
wherein the perfluorosulfonate ionomer is disposed as a continuous and thin layer on few-layer graphene nanosheets in the plurality of few-layer graphene nanosheets.

13. The composition of claim 12, wherein the plurality of few-layer graphene nanosheets is present in a range from 0.5 mg/mL to 5 mg/mL, relative to a total volume of the aqueous dispersion.

14. The composition of claim 12, wherein a weight ratio of the perfluorosulfonate ionomer to the few-layer graphene nanosheets is in a range from 0.1:1 to 10:1.

15. The composition of claim 12, wherein the aqueous dispersion further comprises a water-miscible solvent.

16. The composition of claim is, wherein the water-miscible solvent is a C1 to C4 alcohol.

17. The composition of claim 15, wherein a volume ratio of the water-miscible solvent and water in the aqueous dispersion is in a range from 0.5:1 to 1.5:1.

18. The composition of claim 12, wherein the aqueous dispersion has a lifetime as a stable dispersion of at least one month.

19. The composition of claim 12, wherein the continuous and thin layer of perfluorosulfonate ionomer has a thickness in a range of 2 nm to 100 nm.

20. A method of providing a coated article, the method comprising:
(a) providing a substrate; and
(b) applying the composition of claim 12 to the substrate.
